(19) United States
(12) Patent Application Publication
(10) Pub. No.: US 2025/0209878 A1
(43) Pub. Date: Jun. 26, 2025

(54) CONTROLLING ACCESS TO A PHYSICAL SPACE

(71) Applicant: Zipplify AB, Stockholm (SE)

(72) Inventors: Nathan Davenport, Conyers, GA (US); Anders Ryberg, Särö (SE); Jan Glos, Göteborg (SE); Håkan Rundström, Ljungskile (SE); Joakim Fernstad, Lindome (SE)

(21) Appl. No.: 18/392,350

(22) Filed: Dec. 21, 2023

(51) Int. Cl. G07C 9/33; G07C 9/00

(52) U.S. Cl. CPC G07C 9/33; G07C 9/00182

(57) ABSTRACT

It is provided a method for controlling access to a physical space using an electronic lock, the method being performed in an access control device. The method comprises: obtaining a passcode entered on a keypad, wherein the keypad is associated with a plurality of electronic locks; determining a target lock being an electronic lock that is associated with the passcode, the target lock being one of the plurality of electronic locks that are associated with the keypad; determining that the passcode is valid; and triggering the target lock to be set in a simplified opening state, where no further credential is required to open the target lock.

### TECHNICAL FIELD

The present disclosure relates to the field of controlling access to a physical space and in particular to triggering a target lock to be set in a simplified opening state based on a passcode entered keypad being associated with a plurality of electronic locks.

### BACKGROUND

Locks and keys are evolving from the traditional pure mechanical locks. These days, there are wireless interfaces for electronic locks, e.g. by interacting with an electronic key, that can be provided e.g. in a smartphone of key card. The wireless interface can be implemented e.g. using Bluetooth, Radio Frequency Identification (RFID) or Near-Field Communication (NFC).

One exemplary area where electronic locks are being deployed is for self-storage units. The electronic lock provides improved flexibility and control of access rights, as well as auditing capabilities.

One problem is to enable access for a legitimate user that arrives without bringing the electronic key. It could be possible to add keypads to each electronic lock for access without the electronic key, but adding keypads to each lock would be expensive, consume more power and would result in an aesthetically less pleasing result.

### SUMMARY

One object is to improve efficiency in providing access to an electronic lock when an electronic key is not available.

In some aspects, the embodiments described herein relate to a method for controlling access to a physical space using an electronic lock, the method being performed in an access control device. The method comprises: obtaining a passcode entered on a keypad, wherein the keypad is associated with a plurality of electronic locks; determining a target lock being an electronic lock that is associated with the passcode, the target lock being one of the plurality of electronic locks that are associated with the keypad; determining that the passcode is valid; and triggering the target lock to be set in a simplified opening state, where no further credential is required to open the target lock.

In some aspects, the embodiments described herein relate to that the obtaining a passcode comprises obtaining an identifier of the physical space entered on the keypad.

In some aspects, the embodiments described herein relate to that the determining the target lock comprises determining the target lock based on the passcode.

In some aspects, the embodiments described herein relate to the method further comprising: receiving an enabling signal from an operator terminal, indicating that the target lock is allowed to be set in the simplified opening state; and wherein the triggering the target lock to be set in a simplified opening state is performed conditional on receiving the enabling signal from the operator terminal.

In some aspects, the embodiments described herein relate to the method further comprising: triggering the target lock to be set in a fully locked state after the physical space is closed.

In some aspects, the embodiments described herein relate to that the passcode is valid for a predetermined number of times prior to an electronic key being required to unlock the target lock.

In some aspects, the embodiments described herein relate to that the physical space is a self-storage space.

In some aspects, the embodiments described herein relate to an access control device for controlling access to a physical space using an electronic lock. The access control device comprises: processing circuitry; and memory circuitry storing instructions that, when executed by the processing circuitry, cause the access control device to: obtain a passcode entered on a keypad, wherein the keypad is associated with a plurality of electronic locks; determine a target lock being an electronic lock that is associated with the passcode, the target lock being one of the plurality of electronic locks that are associated with the keypad; determine that the passcode is valid; and trigger the target lock to be set in a simplified opening state, where no further credential is required to open the target lock.

In some aspects, the embodiments described herein relate to that the instructions to obtain a passcode comprise instructions that, when executed by the processing circuitry, cause the access control device to obtain an identifier of the physical space entered on the keypad.

In some aspects, the embodiments described herein relate to that the instructions to determine the target lock comprise instructions that, when executed by the processing circuitry, cause the access control device to determine the target lock based on the passcode.

In some aspects, the embodiments described herein relate to the access control device further comprising instructions that, when executed by the processing circuitry, cause the access control device to: receive an enabling signal from an operator terminal, indicating that the target lock is allowed to be set in the simplified opening state; and wherein instructions to trigger the target lock comprises instructions that, when executed by the processing circuitry, cause the access control device to trigger the target lock to be set in a simplified opening state conditional on receiving the enabling signal from the operator terminal.

In some aspects, the embodiments described herein relate to the access control device further comprising instructions that, when executed by the processing circuitry, cause the access control device to: trigger the target lock to be set in a fully locked state after the physical space is closed.

In some aspects, the embodiments described herein relate to that the passcode is valid for a predetermined number of times prior to an electronic key being required to unlock the target lock.

In some aspects, the embodiments described herein relate to that the physical space is a self-storage space.

In some aspects, the embodiments described herein relate to a computer program for controlling access to a physical space using an electronic lock. The computer program comprises computer program code which, when executed on an access control device causes the access control device to: obtain a passcode entered on a keypad, wherein the keypad is associated with a plurality of electronic locks; determine a target lock being an electronic lock that is associated with the passcode, the target lock being one of the plurality of electronic locks that are associated with the keypad; determine that the passcode is valid; and trigger the target lock to be set in a simplified opening state, where no further credential is required to open the target lock.

In some aspects, the embodiments described herein relate to a computer program product comprising a computer program and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram showing an environment in which embodiments presented herein can be applied;

FIGS. 2A-2C are schematic drawings of how a lever, used for controlling the state of any of the electronic locks of FIG. 1, can be in different positions;

FIGS. 3A-3B are schematic graphs showing current as a function of time for a motor controlling the lever of FIGS. 2A-C in two different scenarios, from an unlocked position to an end position;

FIG. 4 is a flow chart illustrating embodiments of methods for controlling access to a physical space using an electronic lock;

FIG. 5 is a schematic diagram illustrating components of the access control device of FIG. 1; and

FIG. 6 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, an electronic lock can be set in a simplified opening state, where no credential is needed for unlocking, based on entering a passcode on a keypad. The keypad is shared between a plurality of electronic locks, whereby there is no need to have a keypad for each electronic lock. In this way, the electronic lock can be implemented with fewer components while still allowing passcode-assisted unlocking. The electronic lock also supports unlocking based on electronic keys, e.g. in a smartphone, or on a key card.

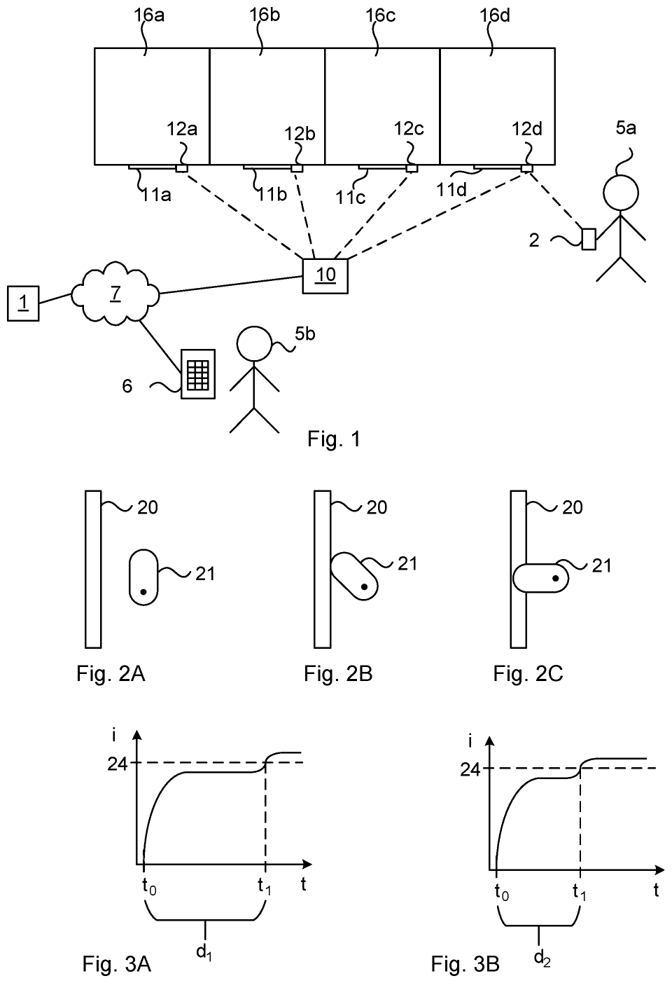

FIG. 1 is a schematic diagram showing an environment in which embodiments presented herein can be applied. Access to a plurality of restricted physical spaces 16a-d is restricted by respective physical barriers 11a-d which are selectively unlockable by respective electronic locks 12a-d. The physical barriers 11a-d stand between the respective restricted physical spaces 16a-d and an accessible physical space 14. It is to be noted that the accessible physical space 14 can be a restricted physical space in itself, but in relation to these physical barriers 11a-d, the accessible physical space 14 is accessible. The barriers 11a-d can be doors, gates, hatches, cabinet doors, drawers, etc. The restricted physical spaces 16a-d can be self-storage units, or any other secured physical space.

Each one of the electronic locks 12a-d has communication capability, e.g. via a gateway 10 to connect to a communication network 7. The communication between the electronic locks 12a-d and the gateway 10 can be provided using any suitable protocol. For instance, this communication can be achieved using low-power mesh network or other power-efficient protocol, e.g. LumenRadio Mira, ZigBee, Bluetooth, BLE (Bluetooth Low Energy), any of the IEEE 802.15 standards, etc. The communication network 7 can e.g. comprise any one or more of a local wireless network, a cellular network, a wired local-area network, a wide-area network (such as the Internet), etc.

A first user 5a carries a portable key device 2. In the example illustrated by FIG. 1, the first user 5a has access to the fourth electronic lock 12d. Each one of the electronic locks 12a-d can communicate with a portable key device 2 using a credential interface over a wireless interface. The portable key device 2 is any suitable device portable by a user 5a-b and which can be used for authentication over the wireless interface. The portable key device 2 is typically carried or worn by the user and may be implemented as a mobile phone, a smartphone, a key fob, wearable device, smartphone case, access card, etc. Using wireless communication, the authenticity and authority of the portable key device 2 can be checked by the electronic lock 12d in an access control procedure, e.g. using a challenge and response scheme, after which the electronic lock 12d grants or denies access. When access is granted, the electronic lock is set in an unlocked state, and the user 5a can enter. As explained in more detail below, the electronic locks 12a-d do not need to have online access to any central component for evaluating whether to grant access.

In the scenario illustrated by FIG. 1, a second user 5b forgot to bring his portable key device. In order to gain access to his physical space, the second user 5b enters a passcode into a keypad 6. The keypad 6 is connected to the communication network 7 and can thereby communicate with an access control device 1. Alternatively, the access control device 1 is provided in the same physical device as the keypad 6. As explained in more detail below, the access control device 1 evaluates validity of the passcode and, if access is granted, the electronic lock that is associated with the second user 5b is set in a simplified opening state. The simplified opening state implies that no credential (e.g. in the form of an electronic key or biometrics) is needed to open the lock. For instance, the electronic lock can have a push button that, when pressed, is sufficient to open the electronic lock when the electronic lock is in the simplified opening state.

While the system is shown in FIG. 1 with four electronic locks 12a-d, the system can be provided with any suitable number of locks.

Network access for each electronic lock 12a-d may be limited. For instance, a communication protocol can be selected where power consumption is given higher priority than communication latency. In this way, the electronic locks 12a-d can be provided that are completely battery-powered, but that still support limited communication with the access control device 1, e.g. to be controlled to be set in a simplified opening state. However, by having limited network access for the electronic locks 12a-d, online access control, where access for a portable key device 2 is checked with a central node in real-time, might not be feasible. Hence, access to the unlock the electronic locks 12a-d can be provided to the portable key device 2 using offline keys.

The offline key solution will now be presented in some more detail.

It has been determined that the portable key device should be provided with an electronic key to a particular electronic lock. In order to provide access, the procedure presented below is performed.
A. Generating, by a central node (such as the access control device 1 or another central node), an electronic key based on a master secret, an identifier of the electronic lock and an identifier of the portable key device. Optionally, this is performed by first generating a lock master key based on the master secret and the identifier of the electronic lock, and subsequently generating the electronic key based on the lock master key and the identifier of the electronic key. In this way, the lock master key can be distributed to the electronic lock without exposing the master secret, which can thereby more securely be used for all electronic lock in the system. The generating can be performed by passing the inputs to a one-way function, such as a hash function, e.g. HKDF (HMAC (Hash-based Message Authentication Code)-based Key Derivation Function), based on SHA256 (Secure Hash Algorithm 256). The master secret can e.g. be a large number. The identifiers (for the electronic lock and the portable key device) can be any alphanumeric string.
B. Providing, by the central node, the electronic key to the portable key device 2. This can e.g. be communicated over the communication network 7, to an application in the portable key device 2.
C. Providing, by the portable key device 2, the identifier of the portable key device 2 to the electronic lock 12. As explained above, this communication can e.g. be performed over a short-range wireless interface.
D. Generating, by the electronic lock 12, its own instance of electronic key, there denoted a verification key. This generating is performed in the same way that was performed by the central node, i.e. based on the master secret, the identifier of the electronic lock 12, and the identifier of the portable key device 2. Optionally, only the lock master key is provided from the central node to the electronic lock 12. The lock master key is generated (in the central node) based on the master secret and the identifier of the electronic lock 12. The electronic lock 12 can thereby generate the verification key for the combination of the electronic lock 12 and the portable key device 2.
E. Proving, by the electronic lock 12, that the portable key device 2 is in possession of the electronic key. This can e.g. be achieved by the electronic lock 12 providing a nonce (e.g. a pseudo-random number) to the portable key device 2, which provides the nonce and the electronic key to a one-way function (e.g. a hash function) to generate a nonce result. The nonce result is sent to the electronic lock 12. The electronic lock 12 can generate the nonce result on its own, based on the verification key and the nonce, and when the nonce results match, this proves that the portable key device 2 is in possession of the electronic key that is identical to the verification key.
F. Unlocking, by the electronic lock, the electronic lock, based on the portable key device 2 having proved possession of the electronic key.

The electronic key is valid for as long as the verification key generated by the electronic lock 12 is the same. Sometimes, an electronic key needs to be invalidated, e.g. for a temporary key or when a new tenant or owner to gain access to the physical space. For the electronic key to be invalidated, the central node performs a secret rotation to provide a new master secret, and a new lock master key can be generated based on the new master secret. When the old lock master key is discarded by the electronic lock 12, any keys based on the old master secret are effectively invalidated; only electronic keys based on the new master secret will be considered valid by the electronic lock 12. No real-time clock is needed is needed in the electronic lock 12 for this procedure. Hence, any portable key device 2 that should still have access needs to be provided with electronic keys based on the new master secret to still have access.

When rotating the master secret, there is optionally an overlap in the electronic lock for a certain amount of time, where both the old master lock key and the new master lock key are valid for a certain period of time. This allows a user to still use an old electronic key for a certain amount of time, in case the portable key device 2 is temporarily offline and is unable to receive the electronic key based on the new master secret.

Alternatively, when rotating the master secret, there is optionally an overlap with two electronic keys, for a certain amount of time. In this case, the portable key device 2 keeps both the original electronic key (based on the old master secret) and the new electronic key (based on the new master secret) for a certain period of time. This allows a user to gain access using any of the two electronic keys for a certain amount of time, in case the electronic lock 12 is temporarily offline and is unable to receive the new master lock key that is based on the new master secret.

The secret rotation can be performed periodically or ad hoc, on demand when one or more electronic keys are to be invalidated.

FIGS. 2A-C are schematic drawings of how a lever 21 used for controlling the state of any of the electronic locks of FIG. 1 can be in different positions. In this example, the lever 21 is rotationally movable. It should be noted that the lever 21 can also be implemented in any other manner (e.g. through translational movement) that allows a motor to control its position to set the electronic lock 12 in a locked or unlocked state. The lever 21 interacts with a cooperating member 20, e.g. a latch, or other selectively movable member, to secure the cooperating member 20 or to allow the cooperating member 20 to move, thereby controlling whether the electronic lock 12 is in an unlocked or locked state.

In the scenario illustrated by FIG. 2A, the lever 21 is away from the cooperating member 20, whereby the cooperating member 20 can move and the electronic lock 12 is in an unlocked state.

In the scenario illustrated by FIG. 2B, the lever 21 has rotated towards the cooperating member 20, but has not engaged with the cooperating member 20. In this scenario, the lever is in an error state in which the cooperating member 20 can move and the electronic lock 12 is still in an unlocked state.

In the scenario illustrated by FIG. 2C, the lever 21 engages with the cooperating member 20, whereby the cooperating member 20 is unable to move and the electronic lock 12 is in a locked state.

FIGS. 3A-B are schematic graphs showing current as a function of time for a motor controlling the lever of FIGS. 2A-C in two different scenarios, from an unlocked position to an end position. The movement from the unlocked state starts at a start time to and ends at an end time t₁. At the start time to, when the motor starts turning, the current increases. At the end time t₁, the lever has reached an end position, and the current increases even further to a higher relatively static level when the motor is prevented from turning further. The current after the motor is blocked from turning further, at the end time t₁, is above a threshold 24. In this way, the electronic lock 12 can determine that the lever is at an end position when the current is above the threshold 24 (optionally for a time period longer than a threshold time period). The turning operation can thus end at this stage.

Looking first to FIG. 3A, the current supplied to the motor is illustrated over time for a normal locking operation of the electronic lock 12, i.e. from the unlocked state illustrated in FIG. 2A to the locked state illustrated in FIG. 2C. A first duration d₁ is defined as the duration between the start time t₀ and the end time t₁ for this scenario of a normal locking operation.

Looking now to FIG. 3B, the current supplied to the motor is illustrated over time for an erroneous operation of the electronic lock 12, i.e. from the unlocked state illustrated in FIG. 2A to the error state illustrated in FIG. 2B. A second duration d₁ is defined as the duration between the start time t₀ and the end time t₁ for this scenario of an erroneous locking operation.

Comparing the locked position of the lever 21 in FIG. 2C and the error position of the lever 21 in FIG. 2B, it can be seen how the lever 21 needs to move further, from the unlocked position of FIG. 2A, to arrive at the end state of the locked position of FIG. 2C than to arrive at the end state of the error position of FIG. 2B. This is also reflected in FIGS. 3A-B, where the first duration d₁, corresponding to moving to the locked position, is significantly longer than the second duration d₂, corresponding to moving to the error position.

This difference in duration is exploited to determine when the electronic lock 12 has successfully transitioned between the unlocked state to the locked state, or when the electronic lock 12 has experienced an erroneous locking operation. This procedure can be performed by the electronic lock 12 and can work according to the following.
A. Determining a start time when movement of the motor has started.
B. Determining an end time when the motor has stopped moving. This can be determined based on the current to the motor exceeding a threshold (optionally for a period of time longer than a threshold).
C. Calculating a closing duration as the duration between the start time and the end time.
D. Determining that the movement was a successful locking movement when the closing duration is longer than a closing threshold.
E. Determining that the movement was an erroneous locking movement when the closing duration is shorter than the closing threshold.

Optionally, the closing threshold depends on temperature. In this case, there is a lookup table or a predefined function, to determine the closing threshold based on a measured temperature. This is to account for the fact that closing operations can be considerably faster at higher temperatures. Optionally, when the measured temperature is not found in the lookup table, the closing threshold is determined by a linear combination of threshold for enveloping temperatures in the lookup table. Optionally, during installation of the electronic lock 12, the duration of a normal closing operation is timed. Any difference in time (for the temperature during installation) compared to the closing threshold in the prestored lookup or predefined function, can be used to determine an offset for the particular electronic lock 12, compensating for variations in closing durations for different electronic locks 12.

When the erroneous locking movement is detected, this can be signalled from the electronic lock 12 to the portable key device 2 and/or the access control device 1. This allows the user to know if a closing operation has not worked and can thus act accordingly to ensure that the physical space is closed and locked.

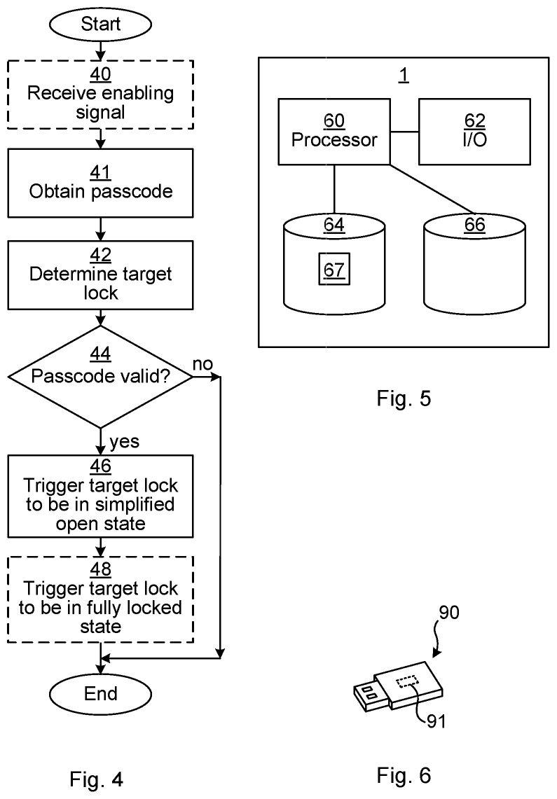

FIG. 4 is a flow chart illustrating embodiments of methods for controlling access to a physical space 16a-d using an electronic lock (denoted the target lock). The method is performed in an access control device 1, such as the access control device 1 of FIG. 1. The physical space 16a-d can e.g. be a self-storage space, as illustrated in FIG. 1.

In an optional receive enabling signal step 40, the access control device 1 receives an enabling signal from an operator terminal, indicating that the target lock 12a is allowed to be set in a simplified opening state, conditional to a valid passcode being entered. The operator can e.g. trigger the enabling signal when a user calls the operator to enable passcode authentication.

In an obtain passcode step 41, the access control device 1 obtains a passcode entered on a keypad 6. The keypad 6 is associated with a plurality of electronic locks 12a-d. The passcode is a sequence of digits and/or other characters, and can e.g. be in the form of a personal identification number (PIN). The length of the passcode can be any number of digits, e.g. four, six, eight, etc.

The passcode can be unique in the system, in which case the passcode is uniquely associated with one of the electronic locks 12a-d. Alternatively, the passcode can be a passcode that is freely set by the user, in which case the user also indicates an identifier of the physical space that the use desires to open. For instance, the passcode can then have two parts, where one part is the identifier of the physical space (e.g. a storage unit number) and another part is the code (e.g. pin code) that is associated with the user and/or target lock. Hence, in this case, the obtaining a passcode comprises obtaining an identifier of the physical space 16a-d entered on the keypad 6.

In a determine target lock step 42, the access control device 1 determines a target lock 12a being an electronic lock that is associated with the passcode. The target lock 12a is one of the plurality of electronic locks 12a-d that are associated with the keypad 6.

Optionally, the target lock is determining based on the passcode. In one embodiment, the passcode is unique within the system, in which case the access control device 1 can determine the target lock based on a lookup table. In one embodiment, as mentioned above, when the user enters the identifier of the physical space on the keypad, this can be used to determine the target lock.

In a conditional passcode valid 44, the access control device 1 determines that the passcode is valid. This check can be performed by checking the passcode against a database of passcodes. When the passcode is valid, the method proceeds to a trigger target lock to be in simplified open state step 46. Otherwise, the method ends.

In the trigger target lock to be in simplified open state step 46, the access control device 1 triggers the target lock 12a to be set in a simplified opening state, where no further credential 2 is required to open the target lock 12a. For instance, the user can then open the lock by pushing a push button provided on the target lock.

When selective provisioning of the enabling signal (mentioned above for the receive enabling signal step 40) is implemented, the triggering 46 the target lock 12a to be set in a simplified opening state is performed conditional on receiving the enabling signal from the operator terminal. In other words, in this case, the operator must trigger the operator terminal to send the enabling signal for passcode-based opening of the target lock to be possible.

Optionally, the passcode is valid for a predetermined number of times prior to an electronic key 2 being required to unlock the target lock 12a. In other words, passcode-based opening is then not possible indefinitely, but only for the predetermined number of times. After that, the electronic key is needed to open the target lock.

In an optional trigger target lock to be in fully locked state step 48, the access control device 1 triggers the target lock 12a to be set in a fully locked state after the physical space is closed. This can e.g. be performed based on user input to lock the target lock, either directly to the target lock or via an application running on a smartphone.

FIG. 5 is a schematic diagram illustrating components of the access control device 1 of FIG. 1. Processing circuitry 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in memory circuitry 64, which can thus be a computer program product. The processing circuitry 60 could alternatively be implemented using an application specific integrated circuit (ASIC), field programmable gate array (FPGA), etc. The processing circuitry 60 can be configured to execute the method described with reference to FIG. 4 above.

The memory circuitry 64 can be any combination of random-access memory (RAM) and/or read-only memory (ROM). The memory circuitry 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processing circuitry 60. The data memory 66 can be any combination of RAM and/or ROM.

The access control device 1 further comprises an I/O interface 62 for communicating with external and/or internal entities. Optionally, the I/O interface 62 also includes a user interface.

An I/O interface 62 is provided for communicating with external and/or internal entities using wired communication, e.g. based on Ethernet, and/or wireless communication, e.g. Wi-Fi, Bluetooth, Bluetooth Low Energy, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components of the access control device 1 are omitted in order not to obscure the concepts presented herein.

FIG. 6 shows one example of a computer program product 90 comprising computer readable means. On this computer readable means, a computer program 91 can be stored in a non-transitory memory. The computer program can cause processing circuitry to execute a method according to embodiments described herein. In this example, the computer program product 90 is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

Here now follows a list of embodiments from another perspective, enumerated with roman numerals.
i. A method for controlling access to a physical space using an electronic lock, the method being performed in an access control device, the method comprising:
obtaining a passcode entered on a keypad, wherein the keypad is associated with a plurality of electronic locks;
determining a target lock being an electronic lock that is associated with the passcode, the target lock being one of the plurality of electronic locks that are associated with the keypad;
determining that the passcode is valid; and
triggering the target lock to be set in a simplified opening state, where no further credential is required to open the target lock.
   ii. The method according to embodiment i, wherein the obtaining a passcode comprises obtaining an identifier of the physical space entered on the keypad.
   iii. The method according to embodiment i or ii, wherein the determining the target lock comprises determining the target lock based on the passcode.
   iv. The method according to any one of the preceding embodiments, further comprising:
receiving an enabling signal from an operator terminal, indicating that the target lock is allowed to be set in the simplified opening state; and
wherein the triggering the target lock to be set in a simplified opening state is performed conditional on receiving the enabling signal from the operator terminal.
   v. The method according to any one of the preceding embodiments, further comprising:
triggering the target lock to be set in a fully locked state after the physical space is closed.
   vi. The method according to any one of the preceding embodiments, wherein the passcode is valid for a predetermined number of times prior to an electronic key being required to unlock the target lock.
   vii. The method according to any one of the preceding embodiments, wherein the physical space is a self-storage space.
   viii. An access control device for controlling access to a physical space using an electronic lock, the access control device comprising:
processing circuitry; and
memory circuitry storing instructions that, when executed by the processing circuitry, cause the access control device to:
obtain a passcode entered on a keypad, wherein the keypad is associated with a plurality of electronic locks;
determine a target lock being an electronic lock that is associated with the passcode, the target lock being one of the plurality of electronic locks that are associated with the keypad;
determine that the passcode is valid; and
trigger the target lock to be set in a simplified opening state, where no further credential is required to open the target lock.
   ix. The access control device according to embodiment viii, wherein the instructions to obtain a passcode comprise instructions that, when executed by the processing circuitry, cause the access control device to obtain an identifier of the physical space entered on the keypad.
   x. The access control device according to embodiment viii or ix, wherein the instructions to determine the target lock comprise instructions that, when executed by the processing circuitry, cause the access control device to determine the target lock based on the passcode.
   xi. The access control device according to any one of embodiments viii to x, further comprising instructions that, when executed by the processing circuitry, cause the access control device to:
receive an enabling signal from an operator terminal, indicating that the target lock is allowed to be set in the simplified opening state; and
wherein instructions to trigger the target lock comprises instructions that, when executed by the processing circuitry, cause the access control device to trigger the target lock to be set in a simplified opening state conditional on receiving the enabling signal from the operator terminal.
   xii. The access control device according to any one of embodiments viii to xi, further comprising instructions that, when executed by the processing circuitry, cause the access control device to:
trigger the target lock to be set in a fully locked state after the physical space is closed.
   xiii. The access control device according to any one of embodiments viii to xii, wherein the passcode is valid for a predetermined number of times prior to an electronic key being required to unlock the target lock.
   xiv. The access control device according to any one of embodiments viii to xiii, wherein the physical space is a self-storage space.
   xv. A computer program for controlling access to a physical space using an electronic lock, the computer program comprising computer program code which, when executed on an access control device causes the access control device to:
obtain a passcode entered on a keypad, wherein the keypad is associated with a plurality of electronic locks;
determine a target lock being an electronic lock that is associated with the passcode, the target lock being one of the plurality of electronic locks that are associated with the keypad;
determine that the passcode is valid; and
trigger the target lock to be set in a simplified opening state, where no further credential is required to open the target lock.
   xvi. A computer program product comprising a computer program
according to embodiment xv and a computer readable means comprising non-transitory memory in which the computer program is stored.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method for controlling access to a physical space using an electronic lock, the method being performed in an access control device, the method comprising:
obtaining a passcode entered on a keypad, wherein the keypad is associated with a plurality of electronic locks;
determining a target lock being an electronic lock that is associated with the passcode, the target lock being one of the plurality of electronic locks that are associated with the keypad;
determining that the passcode is valid; and
triggering the target lock to be set in a simplified opening state, where no further credential is required to open the target lock.

2. The method according to claim 1, wherein the obtaining a passcode comprises obtaining an identifier of the physical space entered on the keypad.

3. The method according to claim 1, wherein the determining the target lock comprises determining the target lock based on the passcode.

4. The method according to claim 1, further comprising:
receiving an enabling signal from an operator terminal, indicating that the target lock is allowed to be set in the simplified opening state; and
wherein the triggering the target lock to be set in a simplified opening state is performed conditional on receiving the enabling signal from the operator terminal.

5. The method according to claim 1, further comprising:
triggering the target lock to be set in a fully locked state after the physical space is closed.

6. The method according to claim 1, wherein the passcode is valid for a predetermined number of times prior to an electronic key being required to unlock the target lock.

7. The method according to claim 1, wherein the physical space is a self-storage space.

8. An access control device for controlling access to a physical space using an electronic lock, the access control device comprising:
processing circuitry; and
memory circuitry storing instructions that, when executed by the processing circuitry, cause the access control device to:
obtain a passcode entered on a keypad, wherein the keypad is associated with a plurality of electronic locks;
determine a target lock being an electronic lock that is associated with the passcode, the target lock being one of the plurality of electronic locks that are associated with the keypad;
determine that the passcode is valid; and
trigger the target lock to be set in a simplified opening state, where no further credential is required to open the target lock.

9. The access control device according to claim 8, wherein the instructions to obtain a passcode comprise instructions that, when executed by the processing circuitry, cause the access control device to obtain an identifier of the physical space entered on the keypad.

10. The access control device according to claim 8, wherein the instructions to determine the target lock comprise instructions that, when executed by the processing circuitry, cause the access control device to determine the target lock based on the passcode.

11. The access control device according to claim 8, further comprising instructions that, when executed by the processing circuitry, cause the access control device to:
receive an enabling signal from an operator terminal, indicating that the target lock is allowed to be set in the simplified opening state; and
wherein instructions to trigger the target lock comprises instructions that, when executed by the processing circuitry, cause the access control device to trigger the target lock to be set in a simplified opening state conditional on receiving the enabling signal from the operator terminal.

12. The access control device according to claim 8, further comprising instructions that, when executed by the processing circuitry, cause the access control device to:
trigger the target lock to be set in a fully locked state after the physical space is closed.

13. The access control device according to claim 8, wherein the passcode is valid for a predetermined number of times prior to an electronic key being required to unlock the target lock.

14. The access control device according to claim 8, wherein the physical space is a self-storage space.

15. A non-transitory computer readable medium storing a computer program for controlling access to a physical space using an electronic lock, the computer program comprising computer program code which, when executed on an access control device causes the access control device to:
obtain a passcode entered on a keypad, wherein the keypad is associated with a plurality of electronic locks;
determine a target lock being an electronic lock that is associated with the passcode, the target lock being one of the plurality of electronic locks that are associated with the keypad;
determine that the passcode is valid; and
trigger the target lock to be set in a simplified opening state, where no further credential is required to open the target lock.
